(19) United States
(12) Patent Application Publication
(10) Pub. No.: US 2013/0022940 A1
(43) Pub. Date: Jan. 24, 2013

(54) METHOD FOR SEALING A ROOT CANAL, AND ROTARY PLUGGER FOR CARRYING OUT THE METHOD

(71) Applicants: Jean-François Peli, Bordeaux (FR); Julien Mordeniz, Besancon (FR)

(72) Inventors: Jean-François Peli, Bordeaux (FR); Julien Mordeniz, Besancon (FR)

(73) Assignee: MICRO MEGA INTERNATIONAL MANUFACTURES, Besancon (FR)

(21) Appl. No.: 13/638,663

(22) PCT Filed: Apr. 18, 2011
(86) PCT No.: PCT/FR11/50881

§ 371 Date: Oct. 1, 2012

(30) Foreign Application Priority Data
Apr. 23, 2010 (FR) 1053108

(51) Int. Cl. A61C 3/08

(52) U.S. Cl. 433/164

(57) ABSTRACT

A rotary rammer is provided which is suitable for the cold filling of a root canal. The rotary rammer includes an active zone having a shoulder and a point. The active zone has a generally conical form, an outer surface of which is smooth, a diameter of a section of the active zone in the vicinity of the point being less than a diameter of a section of the active zone in the vicinity of the shoulder. An end section is provided adjacent to the shoulder of the active zone. The end section has a means for connecting to a mandrel of a mechanical rotational driving device. The rotary rammer is applicable to the dental field.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention relates to a rammer and an associated method for blocking a root canal.

2. Description of Related Art Including Information Disclosed Under 37 CFR 1.97 and 37 CFR 1.98.

The treatment of a dental root with damaged tissues consists in extracting the pulp, shaping the canal then blocking the treated canal with a filling material such as Gutta-Percha, pastes and/or sealing cements.

The shaping of the canal is obtained by successive and scheduled passages of instruments with channels of bore type having different geometrical characteristics (diameter of point, taper, pitch of the helical cutting lips, shape of the section, etc.). After shaping, the canal obtained is curved, of tapered form. The smallest diameter is located at the apex and the greatest diameter at the pulpal floor. The apical zone (commonly called ⅓ apical) of the canal, is the narrowest zone, it is situated in the vicinity of the apex and extends over approximately a third of the total length of the canal, and is the zone most difficult to access. The coronary zone (commonly called ⅔ coronary) of the canal extends between the apical zone and the pulpal floor, over approximately two-thirds of the total length of the canal.

Various blocking techniques exist, notably cold lateral compacting and hot vertical compacting. Lateral compacting consists in the cold compacting using a rammer of a master cone of Gutta-Percha which has to descend to the end of the apical zone. After removal of the rammer, an accessory cone is inserted into the space freed up by the rammer then compacted. The actions of inserting an accessory cone and of compacting said accessory cone are repeated until the root canal is completely blocked. Hot vertical compacting consists in using a rammer to compact a master cone of Gutta-Percha in the apical zone, the rammer and/or the cone of Gutta-Percha being previously heated. The coronary zone is then filled in an identical manner using rammers of greater end diameter and accessory cones of Gutta-Percha. In both cases, the practitioner uses a manual rammer, or a series of manual rammers of increasing diameters. By pushing the rammer into the canal to be filled, the Gutta-Percha is pushed down to the bottom and over the walls of the canal.

These blocking techniques are easy to master for the practitioners but lengthy to implement. The blocking of the canal in fact has to be particularly carefully done, in particular in the apical zone, which is difficult to access and narrow, to create a mechanical sealing zone at the apex. Furthermore, the pressure applied to the walls and the bottom of the canal have to be controlled throughout the compacting operation in order to avoid damaging the walls of the canal and to avoid causing an apical overflow, that is to say a diffusion of the filling material beyond the apex of the canal. Also, the different cones of Gutta have to be perfectly welded to guarantee the mechanical seal.

### BRIEF SUMMARY OF THE INVENTION

The invention proposes a novel rammer, and an associated novel blocking method which does not present all or at least some of the drawbacks or of the difficulties of the known techniques.

More specifically, the invention proposes a rotary rammer which is particularly well suited for implementing a method for blocking a root canal comprising a step of cold compacting a cone of filling material. The rammer according to the invention comprises:
an active zone comprising a shoulder and a point, the active zone having a generally conical form, an outer surface of which is smooth, a diameter of a section of the active zone in the vicinity of the point being less than a diameter of a section of the active zone in the vicinity of the shoulder, and
an end section adjacent to the shoulder of the active zone, the end section comprising a means for connecting to a mandrel of a mechanical rotational driving device.

The general form of the cone facilitates the insertion of the rammer into the canal. The smooth outer surface of the rammer avoids damaging the walls of the canal.

The rammer connection means allows for it to be used with a handpiece or with an anglepiece for a mechanical rotational driving. The rotational movement allows for a better application of the filling material against the side walls of the canal. The rotational movements are thus better controlled, more even, with no particular effort on the part of the practitioner.

Moreover, the energy generated by the friction of the rammer rotating against the filling material reheats the filling material which is thus made more fluid. The filling material can thus more easily and more effectively be pushed down to the bottom of the apical canal and against, the walls of the root canal. Furthermore, the prior heating of the filling material becomes unnecessary. Moreover, since the friction energy transmitted to the filling material is a function of the rotation speed of the rammer, the practitioner can easily adjust the speed of rotation according to the fluidity desired for the filling material.

The point of the rammer can have a flat, ogival or conical end. A flat end limits the risks of damaging the apex when the rammer is used to compact the ⅓ apical. An ogival or conical end facilitates the compacting of an accessory cone in the space left free by the removal of the rammer used for the compacting of the preceding cone.

A rammer according to the invention can be used in the same situations as a manual rammer that has an identical active part (same length, same taper, etc.): they can penetrate into the canals to the same depths to compact the master cone and the accessory cones; the spaces left free (and having to be filled by the accessory cones) after removal of the rammer are the same.

However, surprisingly, the rammer according to the invention, used at a slower rotation speed compared to the speeds commonly used in this field in particular for the preparation of the apical canal, of the order of 100 to 1000 revolutions per minute, gives much better results than a manual rammer that has an identical active part. For example, experiments have shown that the force to be exerted on the rammer rotating at approximately 300 to 600 revolutions/minute to descend into the apical third and to crush and compact a cone of Gutta in the ⅓ apical is of the order of 0.3 kg, whereas it is of the order of 1.5 kg for a manual rammer. The lower pressure greatly limits the risks of damaging the walls and the apex of the canal, and facilitates the use of the rammer. Also, the thermomechanical effect of softening the filling material by a rammer according to the invention facilitates the crashing and the molding of the master cone over the limits of the canal. Also, the thermomechanical effect of the rotary rammer according to the invention increases the cohesion of the master cone and of the accessory cones, particularly in the ⅓ apical.

### BRIEF DESCRIPTION OF THE SEVERAL VIEWS OF THE DRAWINGS

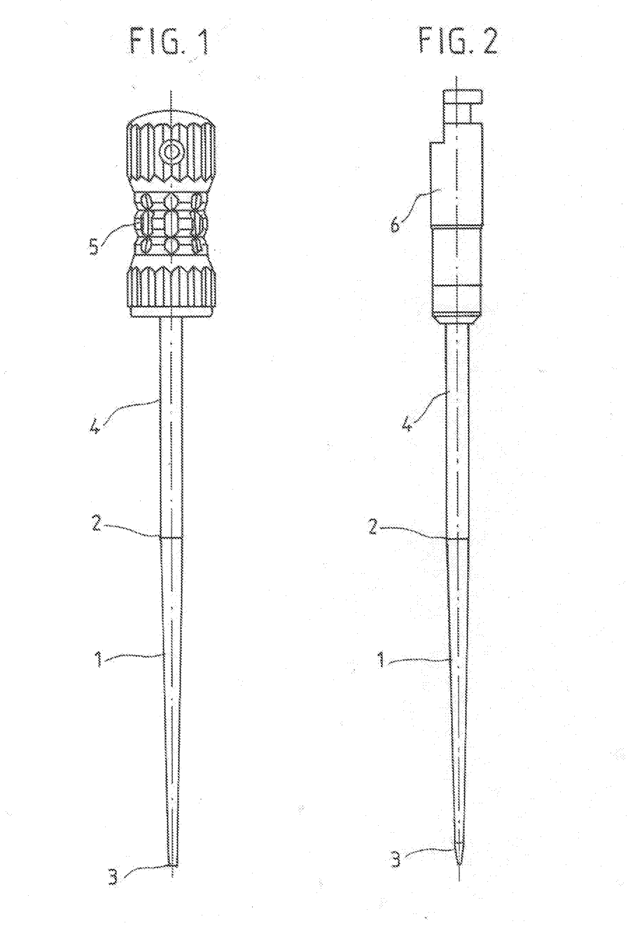

The invention will be better understood, and other features and advantages of the invention will become apparent in light of the following description of two embodiments of rotary rammers according to the invention, represented respectively in FIGS. 1 and 2.

### DETAILED DESCRIPTION OF THE INVENTION

The rammers of FIGS. 1, 2 each comprise:
an active zone 1 comprising a shoulder 2 and a point 3; the active zone 1 has a generally conical form, an outer surface of which is smooth, a diameter of a section of the active zone in the vicinity of the point being less than a diameter of a section of the active zone in the vicinity of the shoulder, and
an end section 4 adjacent to the shoulder 3 of the active zone 1.

The generally conical form of the active zone has a taper of between, for example, 0 and 10%. A kit comprising rammers of increasing taper can also be produced.

According to the invention, the outer surface of the active zone is perfectly smooth: it has no cutting lip, no boss, no hollow, no unevenness of any form whatsoever. Thus, when the rammer is driven in rotation and when its surface touches the internal surface 1 of the canal to be blocked, the rammer does not damage the wall of the canal.

In the rammer of FIG. 1, the end section 4 is terminated by a sleeve 5 for gripping the rammer by hand, and the point 3 is planar. On the rammer of FIG. 2, the end section 4 is terminated by a means 6 for connecting to a mandrel (not represented) of a mechanical rotational driving device, and the point is ogival.

The rammers are made of a flexible and mechanically strong material, for example of nickel-titanium, of steel or of a composite material.

1. Rotary rammer suitable for filling a root canal, comprising:
an active zone comprising a shoulder and a point, the active zone having a generally conical form, an outer surface of which is smooth, a diameter of a section of the active zone in the vicinity of the point being less than a diameter of a section of the active zone in the vicinity of the shoulder; and
an end section adjacent to the shoulder of the active zone, the end section comprising a means for connecting to a mandrel of a mechanical rotational driving device.

2. The rammer as claimed in claim 1, in which the point has a flat, ogival or conical end.

3. The rammer as claimed in claim 1, the active zone of which has a taper of between 0 and 10%.

4. The rammer as claimed in claim 1, made of nickel-titanium, of steel or of a composite material.
